(19) United States
(12) Patent Application Publication
(10) Pub. No.: US 2006/0083488 A1
(43) Pub. Date: Apr. 20, 2006

(54) Allocation and scheduling strategy for improved trick play performance and temporal scalability

(76) Inventors: Jozef Pieter Van Gassel, Eindhoven (NL); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/536,967

(22) PCT Filed: Oct. 31, 2003
(86) PCT No.: PCT/IB03/05031

§ 371 Date: May 31, 2005

(30) Foreign Application Priority Data
Dec. 5, 2002 (EP) 02080113.0

(51) Int. Cl. H04N 7/26

(52) U.S. Cl. 386/111; 386/112

(57) ABSTRACT

A method and apparatus for recording a data stream on a storage medium for improving non-linear playback performance of the recorded data is disclosed. First, the data stream is received. The I-pictures from the data stream are stored in a first buffer and the remaining data from the data stream is stored in a second buffer. Each time the first buffer becomes full, the I-pictures stored in the first buffer are written onto an intra-coded allocation unit on the storage medium. Then, the contents of the second buffer are written onto preferably a subsequent inter-coded allocation unit.

The invention relates to non-linear playback (trick play, scalable video formats, etc.) of digital video data, and more particularly to a method and apparatus for allocation and scheduling for improved trick play performance and temporal scalability.

With the introduction of digital consumer recording systems like DVD-recorders and hard disk recording systems, consumers will increasingly start recording digital broadcasts and self-encoded MPEG-video material. In such systems, the consumer expects at least the same functionality and performance as conventional analog video recording systems (e.g. VCRs). In random access media based recording systems, for example, hard disks and optical discs, the MPEG encoded material is sequentially written to the storage medium as it enters the recorder (or leaves the encoder). For certain fast trick play modes of operation, this leads to a very inefficient utilization of the drive.

Fast forward and reverse operations lead to excessive seeking of the bit-engine because of the jumps from I-picture to I-picture. This has a number of major disadvantages, such as a significant performance penalty, drive wear and tear, and noise caused by the seeking operations. Thus, there is a need for a method and apparatus for recording data in such a manner so as to avoid the problems cited above.

It is an object of the invention to overcome the above-described deficiencies by providing a method and apparatus for allocation and scheduling of recorded data for improved trick play performance and temporal scalability. The invention offers a mechanism to store the video data on the disc in such a manner that the seeking is minimized. In addition, the allocation strategy offers another advantage, a very simple type of temporal scalability. This can be particularly useful for mobile devices to extend battery life or reduce interface bandwidth (at the expense of picture refresh rate) for networking. The invention is aimed at consumer recorders but can also be applied to large video-on-demand systems where multiple trick play streams should be handled simultaneously.

According to one embodiment of the invention, a method and apparatus for recording a data stream on a storage medium for improving non-linear playback performance of the recorded data is disclosed. First, the data stream is received. The I-pictures from the data stream are stored in a first buffer and the remaining data from the data stream is stored in a second buffer. Each time the first buffer becomes full, the I-pictures stored in the first buffer are written onto an intra-coded allocation unit on the storage medium. Then, the contents of the second buffer are written onto preferably a subsequent inter-coded allocation unit.

According to another embodiment of the invention, a method and apparatus for recording a data stream on a storage medium for improving non-linear playback performance of the recorded data is disclosed. First, the data stream is received. The I-pictures from the data stream are stored in a first buffer. The P-pictures and non-video data from the data stream are stored in a second buffer. The B-pictures from the data stream are stored in a third buffer. Each time the first buffer becomes full, the I-pictures stored in the first buffer are written onto an intra-coded allocation unit on the storage medium. The contents of the second buffer are written into at least one P-picture allocation unit which typically follows the previously written intra-coded allocation unit. The contents of the third buffer are written into a B-picture allocation unit which follows the at least one P-picture allocation unit.

These and other aspects of the invention will be apparent from and elucidated with reference to the embodiments described hereafter.

The invention will now be described, by way of example, with reference to the accompanying drawings, wherein:

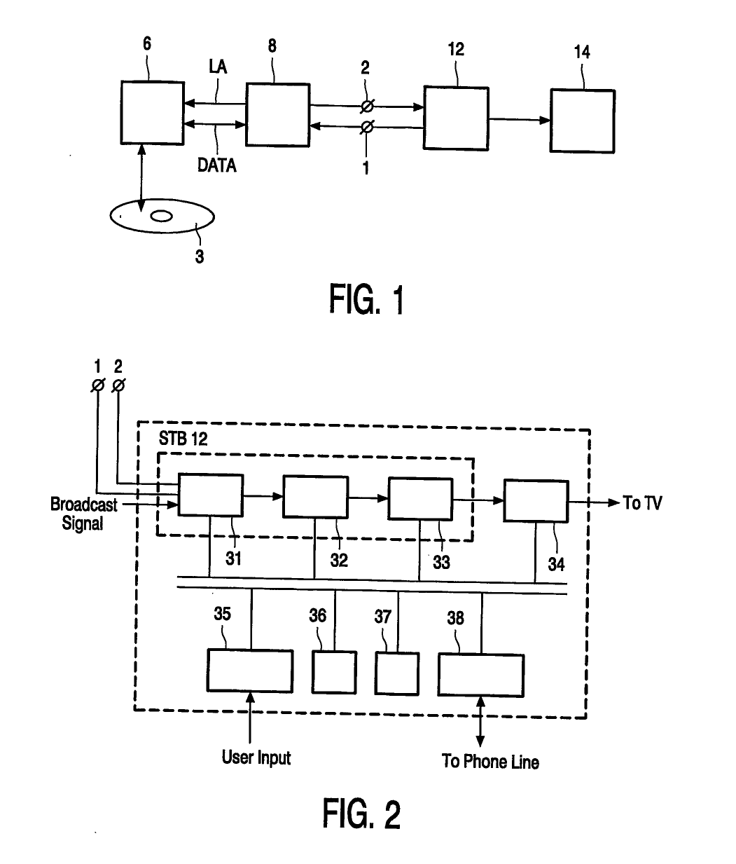

FIG. 1 illustrates a block diagram of a audio-video apparatus suitable to host embodiments of the invention;

FIG. 2 illustrates a block diagram of a set-top box which can be used to implement at least one embodiment of the invention;

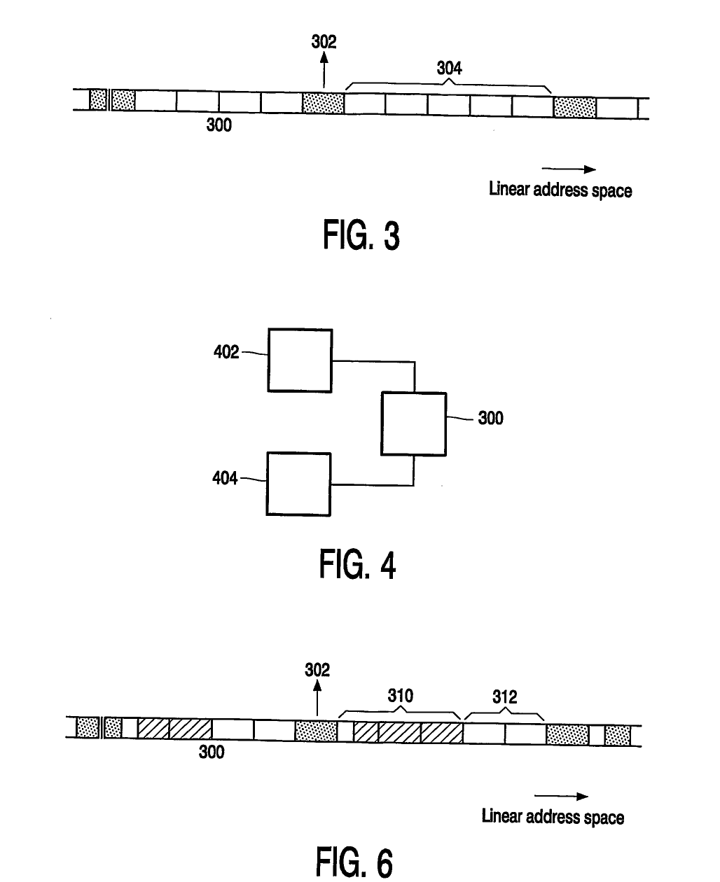

FIG. 3 illustrates a storage medium according to one embodiment of the invention;

FIG. 4 illustrates a recording apparatus according to one embodiment of the invention;

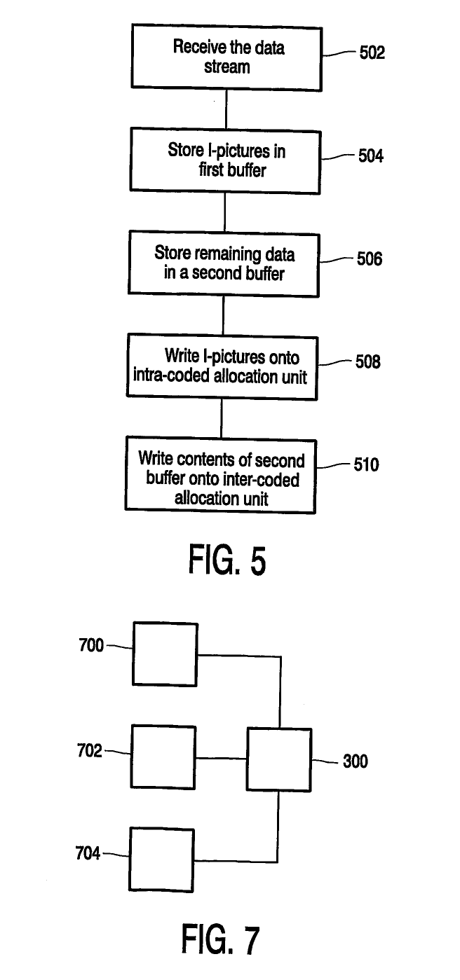

FIG. 5 is a flow chart which illustrates the storage of a data stream according to one embodiment of the invention;

FIG. 6 illustrates a storage medium according to one embodiment of the invention;

FIG. 7 illustrates a recording apparatus according to one embodiment of the invention;

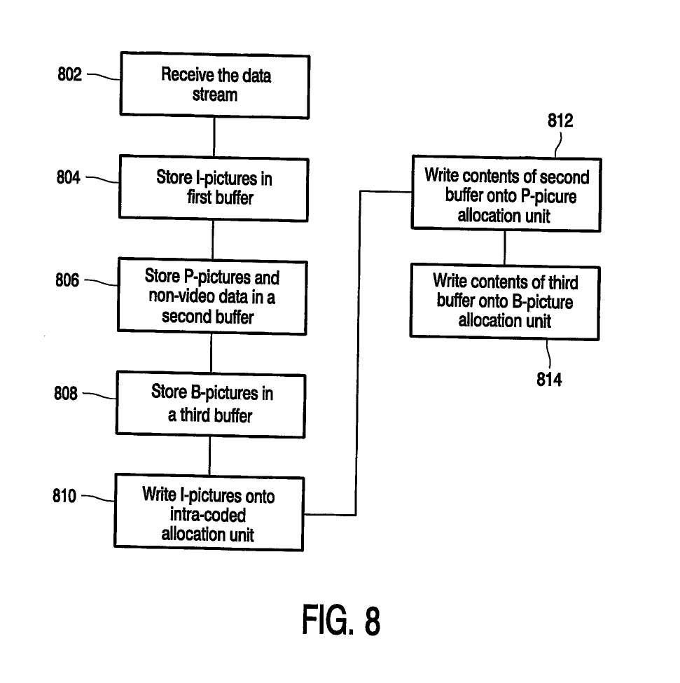

FIG. 8 is a flow chart which illustrates the storage of a data stream according to one embodiment of the invention.

FIG. 1 illustrates and audio-video apparatus suitable to host the invention. The apparatus comprises an input terminal 1 for receiving a digital video signal to be recorded on a disc 3. Further, the apparatus comprises an output terminal 2 for supplying a digital video signal reproduced from the disc. These terminals may in use be connected via a digital interface to a digital television receiver and decoder in the form of a set-top box (STB) 12, which also receives broadcast signals from satellite, cable or the like, in MPEG TS format. While the MPEG format is being discussed, it will be understood by those skilled in the art that other formats with a similar IPB-like structure can also be used. The set-top box 12 provides display signals to a display device 14, which may be a conventional television set.

The video recording apparatus as shown in FIG. 1 is composed of two major system parts, namely the disc subsystem 6 and the video recorder subsystem 8, controlling both recording and playback. The two subsystems have a number of features, as will be readily understood, including that the disc subsystem can be addressed transparently in terms of logical addresses (LA) and can guarantee a maximum sustainable bit-rate for reading and/or writing data from/to the disc.

Suitable hardware arrangements for implementing such an apparatus are known to one skilled in the art, with one example illustrated in patent application WO-A-00/00981. The apparatus generally comprises signal processing units, a read/write unit including a read/write head configured for reading from/writing to disc 3. Actuators position the head in a radial direction across the disc, while a motor rotates the disc. A microprocessor is present for controlling all the circuits in a known manner.

Referring to FIG. 2, a block diagram of a set-top box 12 is shown. It will be understood by those skilled in the art that the invention is not limited to a set top box but also extends to a variety of devices such as a DVD player, PVR box, a box containing a Hard disk (recorder module), etc. A broadcast signal is received and fed into a tuner 31. The tuner 31 selects the channel on which the broadcast audio-video-interactive signal is transmitted and passes the signal to a processing unit 32. The processing unit 32 demultiplexes the packets from the broadcast signal if necessary and reconstructs the television programs and/or interactive applications embodied in the signal. The programs and applications are then decompressed by a decompression unit 33. The audio and video information associated with the television programs embodied in the signal is then conveyed to a display unit 34, which may perform further processing and conversion of the information into a suitable television format, such as NTSC or HDTV audio/video. Applications reconstructed from the broadcast signal are routed to random access memory (RAM) 37 and are executed by a control system 35.

The control system 35 may include a microprocessor, micro-controller, digital signal processor (DSP), or some other type of software instruction processing device. The RAM 37 may include memory units which are static (e.g. SRAM), dynamic (e.g. DRAM), volatile or non-volatile (e.g., FLASH), as required to support the functions of the set-top box. When power is applied to the set-top box, the control system 35 executes operating system code which is stored in ROM 36. The operating system code executes continuously while the set-top box is powered in the same manner as the operating system code of a typical personal computer and enables the set-top box to act on control information and execute interactive and other applications. The set-top box also includes a modem 38. The modem 38 provides both a return path by which viewer data can be transmitted to the broadcast station and an alternate path by which the broadcast station can transmit data to the set-top box.

Although the term “set-top box” is used herein, it will be understood that this term refers to any receiver or processing unit for receiving and processing a transmitted signal and conveying the processed signal to a television or other monitor, and networked devices separated from a rendering/display device via a network connection. The set-top box may be in a housing which physically sits on top of a television, it may be in some other location from the television, or it may be incorporated into the television itself.

According to one embodiment of the invention, a combined scheduling and allocation strategy to enhance non-linear or non-real time playback performance and facilitate temporal scalability is disclosed. Non-linear playback refers to trick play operations, e.g., fast forward and reverse, as well as playing back stored layered/scalable audio/video formats such as temporal, SNR and spatial scalability. This is achieved by allocating the I-pictures in separate allocation units on the disk at the time of recording. As illustrated in FIG. 3, intra-coded allocation units 302 are used for storing I-pictures while inter-coded allocation units 304 are used to store B-, P-pictures. The data in the intra-coded allocation units are coded with a first coding algorithm and the data in the inter-coded allocation units are coded with a second coding algorithm, wherein coding algorithm refers to compression techniques and scalable/layered formats such as, for example, spatial and SNR coding. These separate intra- and inter-coded allocation units are written interleaved but preferably contiguously to a storage medium 300. Since the start and stop location of these I-pictures are already available from a CPI-extraction algorithm, this does not significantly add to the complexity of the recorder. As illustrated in FIG. 4, by separating the scheduler buffers for the I-pictures and the rest of the stream, one intra-coded scheduler buffer 402 is used to store the I-pictures and another inter-coded scheduler buffer 404 is used for the P- and B-pictures and non-video data. It will be understood by one skilled in the art that a single buffer could also be used as long as the system keeps track of where the I-pictures boundaries are within the single scheduler buffer.

As soon as one of the scheduler buffers in memory contains enough data to fill an entire allocation unit, the buffer content can be written to the storage medium 300. For a typical DVB stream with an average GOP-size c_{G}=390 kB and the I-picture size c_{I}=75 kB, it can be concluded that for the recorded DVB broadcast streams roughly every four to five allocation units will be inter-coded allocation units 304 on the storage medium 300. At the end of this specification, an illustrative algorithm is shown which re-interleaves the output of the separate buffers in to a single MPEG-stream, identical to the original stream, without the need for any a-priori knowledge, i.e., extra meta data, on the positions of individual pictures in the storage medium 300.

At normal play back speed, every intra-coded allocation unit 302 contains at least all of the I-pictures needed to decode the inter-coded pictures in all subsequent intercoded allocation units 304 until the next intra-coded allocation unit 302. This guarantees that no extra jumping or seeking is required during normal play back of such streams. This is of particular importance when I-pictures would exceed allocation unit boundaries, and might either require the scheduler buffers to be slightly larger than twice the single buffer size or necessitates the use of a stuffing mechanism to fill up allocation units. Note that this implies that the allocation units contain an integral number of pictures. It will be understood by one skilled in the art that multiple intra-coded allocation units can be written before starting to write the associated inter-coded data and non-video data.

Using this allocation strategy during trick play, ensures that it is no longer necessary to perform a seek operation in between I-pictures and eliminates the need to read inter-coded data, which is not used during trick play operation, from the storage medium 300. Another advantage is that, during recording and normal play, there will not be any extra performance penalty since the intra-coded allocation units are interleaved with the intercoded picture allocation units on the disc. In other words, no extra time-consuming seeking is used at record time and normal play back.

By using this allocation method, it should be noted that I-pictures do not necessarily start and end on program stream or transport stream packet boundaries. This requires processing of leading and trailing packets of every intra-coded picture and its neighboring inter-coded pictures. Since such start and end detection of pictures is already available in recorders in the form of CPI-extraction, the available functionality can be used to find these picture boundaries within the transport packet. Subsequently, stuffing in the adaptation field of the transport stream packet can be applied in order to remove unwanted residuals at recording time, wherein the extra required processing is minimal.

The fact that the intra-coded pictures are separately allocated on the storage medium has some other less obvious advantages. For example, the allocation makes it much easier to analyze the content, e.g., generating thumbnails, scene change detection and generating summaries, since I-pictures, which are often used for these purposes are no longer distributed over the storage medium. For conditional access (CA) systems, this separation can also be advantageous in the sense that different encryption mechanisms can be applied for intra- and inter-coded data. In such CA systems, I-pictures are sometimes stored in the clear, i.e., not encrypted, in order to facilitate trick play whereas the P- and B-pictures are stored encrypted.

In order to demonstrate the improvement of the invention, a worst-case analysis will now be described. This analysis assumes I-picture sizes of c_{I}=75 kB and the average GOP-sizes of c_{G}=390 kB. The numbers refer to partial transport stream sizes and therefore also include a slight overhead for audio, system information, and other data. Assuming that APATs are stored as well, this leads to an average I-picture size of 400 transport stream packets (of each 192 bytes). For the hard disk case with block or allocation unit size of B=4 MB, the system can store on average
B/c_{I}=54.6,
intra-coded pictures in a single allocation unit on the storage medium 300. The allocation units or blocks are the units allocated on the storage medium 300 within which the video is guaranteed to be stored contiguous. This leads to the following I-picture troughput rate of the system of
f_{I}=BR/c_{I}(RTₛₑₑₖ+B)=260.8
pictures per second with a sustainable user data rate of R=196 Mbps (a typical hard disc drive). For a worst case situation, this is more than a five-fold improvement over the normally used allocation strategy of current recorders. Furthermore, the number of seek operations required is heavily decreased, which will be beneficial to the life expectancy of the drive and the noise level of the system.

FIG. 5 is a flow chart which illustrates the storage and reading back of a data stream according the above-described embodiment of the invention. First, the data stream is received in step 502. The I-pictures from the data stream are then stored in a first buffer in step 504 and the remaining data from the data stream is stored in a second buffer in step 506. Each time the first buffer becomes full, the I-pictures stored in the first buffer are written onto an intra-coded allocation unit on the storage medium in step 508. Then, the contents of the second buffer are written onto preferably a subsequent inter-coded allocation unit in step 510.

According to another embodiment of the invention, optimum allocation in combination with a very low complexity form of temporal scalability can be achieved. The temporal scalability is achieved by storing P- and B-pictures in separate allocation units on the storage medium, as illustrated in FIG. 6. In FIG. 6, each intra-coded allocation unit 302 is followed by at least one P-picture allocation unit 310 and at least one B-picture allocation unit 312. As illustrated in FIG. 7, three buffers are used for storing the data stream. A first buffer 700 stores the I-pictures. A second buffer 702 stores the P-pictures and non-video data in this example. A third buffer 704 stores the B-pictures. No extra provisions in the encoder are required, i.e., it is compatible with existing codecs, to obtain this type of scalability. Scalability is of particular importance for mobile devices where power consumption constraints can prevail over video quality. Furthermore, this scalability can be extremely useful for networked devices where transport of video data over a digital interface with lower bandwidth than the actual video stream is required.

This temporal video scalability can be realized in two different ways. First, the frame refresh rate of the internal decoder can be reduced at play back, or in the case of play back over the digital interface, by inserting empty pictures at the position of skipped original pictures on play back to achieve effectively the same result. It should be noted that because this scalability does not influence the duration of the video on play back, the audio data is left unchanged and can therefore be decoded at the normal play back speed in sync with the video material. In order for this to work, all non-video data, also referred to as other data, e.g., audio data, private data, interactive TV-data and SI-information is stored separately and preferably contiguously with respect to the I-picture allocation units either at the end of the I-picture allocation unit 302 or start of P-picture allocation units 310 as illustrated in FIG. 4.

The private data may comprise any kind of content description data, compliant to an open standard like MPEG7 or TV-anytime. The interactive TV-data is preferably compliant to the DVB-MHP standard, but may be just as well compliant to DASE.

Since no pictures are predicted from the B-pictures, the B-pictures can be sub sampled on the play back at will. As an example, lets take an encoded video stream with a GOP length N=12 and an anchor-picture distance of M=4. This GOP structure can potentially reduce the number of different pictures that need to be decoded per second by: a factor of 12 by only playing back the I-pictures; a factor of 4 by skipping all B-pictures; a factor of 2 by playing back all I- and P-pictures and middle B-pictures; and a factor of 1 by playing back all I-, P-, and B-pictures. This leads to picture refresh rates of 2.08 Hz, 6.35 Hz, 12.5 Hz and 25 Hz, respectively, at an original frame rate of 25 frames per second. Note, for example, that by playing back two out of three B-pictures other refresh rates can be achieved, but at an irregular picture sampling interval. This will likely lead to annoying visual artifacts such as jerkiness of the picture.

Assuring that the macroblock throughput scales linearly with power consumption, the temporal scalability can lead to a reduction in power consumption of the video decoder by the respective sub sampling factors. Also less data needs to be retrieved, leading to another significant reduction in power consumption. By choosing a particular GOP structure, the granularity of the temporal scalability can be influenced. Note that by putting the B- and P-pictures into the same allocation units, a course form of the scalability (by a factor equal to the GOP-length N) can be achieved.

Using this allocation strategy not only reduces the required decoder power consumption but also leads to an optimum allocation in terms of power consumption for the storage engine. This is due to the fact that the allocation strategy guarantees that the number of medium accesses is minimized for different levels of granularity. In case of a mobile device running low on battery power where play back of the currently streaming video cannot be guaranteed, the power of the drive and decoder can be reduced to extend battery life. This type of allocation also improves performance for IPP based trick modes wherein allocation units are no longer polluted with unwanted B-pictures.

FIG. 8 is a flow chart which illustrates the storage and reading back of a data stream according the above-described embodiment of the invention. First, the data stream is received in step 802. The I-pictures from the data stream are stored in a first buffer in step 804. The P-pictures and non-video data from the data stream are stored in a second buffer in step 806. The B-pictures from the data stream are stored in a third buffer in step 808. Each time the first buffer becomes full, the I-pictures stored in the first buffer are written onto an intra-coded allocation unit on the storage medium in step 810. The contents of the second buffer are written into at least one P-picture allocation unit which typically follows the previously written intra-coded allocation unit in step 812. The contents of the third buffer are written into a B-picture allocation unit which follows the at least one P-picture allocation unit in step 814.

As an alternative, it is possible to store the audio and system information combined with empty pictures together in the I-pictures, P-pictures and B-pictures allocation units as well. In this illustrative example, the non-video data is duplicated three times, but the overhead is negligible. This offers the following three layers of operation. First, read I-pictures where the allocation units include added empty pictures with the non-video data interleaved. Note that all audio data is interleaved with I-pictures in the same allocation units. Second, read I-pictures and P-pictures and the non-video data is interleaved with the I- and P-pictures. On play back, the empty pictures in the I-picture section and the audio that is interleaved is skipped. This part is duplicated again with the P-pictures in such a way that on play back all audio data is available. Third, read I-pictures, P-pictures, B-pictures and the non-video data is interleaved with the I-, P-, B-pictures. The empty pictures in the I-picture and P-picture allocation units, and the non-video data interleaved with it, are skipped on play back. Again, the non-video data interleaved with the original I-, P- and B-pictures will result in the complete audio stream.

If properly structured, any of the above mentioned combinations can lead to a valid MPEG-stream, although some of the non-video data is duplicated and sometimes empty pictures are skipped on play back. For very low bit rates, temporal scalability is a nice type of scalability because it does not reduce the picture quality but only the picture refresh rate. Furthermore, a similar separation on the storage medium results in similar advantages for other types of layer compression formats, such as spatial and SNR scalability.

At normal speed play back, the intra- and inter-coded allocation blocks have to be re-multiplexed into a single MPEG-compliant video stream again. This can be done on the basis of the temporal references of the MPEG pictures, i.e., access units. A general algorithm to achieve this re-interleaving is given in the pseudo C-code below but the invention is not limited thereto:

While (“I-picture Buffer is not empty”
{

prev = −1
curr = “TemporalReference of first I-picture in buffer”
“Remove I-picture from buffer and send it over digital interface”
for (int I = prev + 1; I < curr; I++)
{
“remove B-picture from buffer and send it over digital interface”
}

while (“TemporalReference of next P-picture in buffer” > curr)

{

prev = curr;
curr = “ TemporalReference of first P-picture in buffer”
“Remove I-picture from buffer and send it over digital interface”
for (int I = prev + 1; I < curr; I++)
{
“remove B-picture from buffer and send it over digital interface”
}

}

}

The algorithm works for the two buffer embodiment (separate intra- and intercoded buffers) as well as the three buffer (separate I-, P-, and B-picture buffers) embodiment. The variables “prev” and “curr” respectively denote the temporal references of the previous and current anchor pictures in the currently processed GOP. The only assumption is that at the start of processing, the read pointers in the three buffers are synchronized, i.e., all point to the correct corresponding entries.

Assuming that the first picture in the inter-coded block starts with the intercoded picture immediately following the first I-picture of the intra-coded allocation unit, the system can reconstruct the original video stream without the need of any extra information as described above. For random access systems however, it might be required to add an extra field to the CPI-information table that contains a reference to the location of this inter-coded picture in order to be able to facilitate random access for I-pictures after the first I-picture of an allocation unit.

It will be understood that the different embodiments of the invention are not limited to the exact order of the above-described steps as the timing of some steps can be interchanged without affecting the overall operation of the invention.

For example, instead of using the disk 3 (FIG. 1), a solid state memory like a Flash card may be used. Also, a compression algorithm using intra-coded and inter-coded pictures other than MPEG 2 may be used without departing from the scope of the invention.

Furthermore, the term “comprising” does not exclude other elements or steps, the terms “a” and “an” do not exclude a plurality and a single processor or other unit may fulfill the functions of several of the units or circuits recited in the claims.

The invention can be summarised as follows:

A method and apparatus for recording a data stream on a storage medium for improving non-linear playback performance of the recorded data is disclosed. First, the data stream is received. The I-pictures from the data stream are stored in a first buffer and the remaining data from the data stream is stored in a second buffer. Each time the first buffer becomes full, the I-pictures stored in the first buffer are written onto an intra-coded allocation unit on the storage medium. Then, the contents of the second buffer are written onto preferably a subsequent inter-coded allocation unit.

1. A method for storing a data stream comprising intra-coded pictures and intercoded pictures on a storage medium comprising at least one intra-coded allocation unit and at least one inter-coded allocation unit, the method comprising the steps of:
a) receiving the data stream;
b) storing multiple intra-coded pictures in the intra-coded allocation unit on the storage medium;
c) storing multiple inter-coded pictures in the inter-coded allocation unit on the storage medium.

2. Method according to claim 1, wherein the data stream comprises further data other than coded pictures and the further data I stored in the intra-coded allocation unit

3. Method according to claim 1, wherein the inter-coded allocation unit is preceded by the intra-coded allocation unit and the inter-coded pictures stored in the intercoded allocation unit are associated with the intra-coded pictures stored in the preceding intra coded allocation unit.

4. Method according to claim 1, further comprising the steps of:
a) receiving a trick play request for the stored data; and
b) reading the data in the intra-coded allocation units to create the requested trick play stream of recorded data.

5. method according to claim 1, wherein data in the intra-coded allocation units are coded with a first coding algorithm and the data in the inter-coded allocation units are coded with a second coding algorithm.

6. Apparatus for storing a data stream comprising intra-coded pictures and intercoded pictures on a storage medium comprising at least one intra-coded allocation unit and at least one inter-coded allocation unit, the apparatus further comprising:
a) a receiver for receiving the data stream;
b) means for storing multiple intra-coded pictures in the intra-coded allocation unit on the storage medium;
c) means storing multiple inter-coded pictures in the inter-coded allocation unit on the storage medium.

7. storage medium comprising
a) at least one intra-coded allocation unit for storing multiple intra-coded pictures; and
b) at least one inter-coded allocation unit for storing multiple inter-coded pictures.
